(19) United States
(12) Patent Application Publication
(10) Pub. No.: US 2017/0024813 A1
(43) Pub. Date: Jan. 26, 2017

(54) System and Method for Provisioning Financial Transaction Between a Lender and a Borrower

(71) Applicant: MB Technology Partners Ltd., Singapore (SG)

(72) Inventors: Charles Hugues Max Crouspeyre, Singapore (SG); Pietro Ventani, Singapore (SG); Jeroen Eric van Overbeek, Bali (ID)

(21) Appl. No.: 14/806,101

(22) Filed: Jul. 22, 2015

(51) Int. Cl. G06Q 40/02

(52) U.S. Cl. CPC G06Q 40/025

(57) ABSTRACT

The present disclosure relates to system(s) and method(s) for connecting entrepreneurs/borrowers with lenders. The system also maintains a mobile platform to enable the borrowers to generate a borrower profile by providing critical information associated with themselves and/or their enterprise. Further, a web platform may be used by the lenders to browse through different borrower profiles created by borrowers and select a profile to prospect lending opportunities suitable to their needs. Further, the system also provides the moneylenders with an analysis tool to assess and manage the credit risk, sign online loan contracts, and monitor its performance. Once a loan has been agreed, the system provides with the means for the lenders to disburse and for the borrowers multiple options to receive and repay money respectively including the option to employ virtual or cryptocurrency.

### TECHNICAL FIELD

The present disclosure in general relates to the field of financial transactions. More particularly, the present invention relates to a system and method for enabling secure financial exchange between a lender and a borrower.

### BACKGROUND

Small and Micro enterprises (potential borrowers/borrowers) contribute a major component of the economic growth across the world. These enterprises employ very large segments of the active population throughout the world. In majority of the cases, such enterprises are run by entrepreneurs/individuals typically working with family members and are often located in the less affluent segments of society. Though majority of these enterprises have a potential to grow into large organizations, however the lack of financial support from recognized funding sources such as banks and financial institutions is the biggest barrier in their growth. The primary reasons why banks and financial institutions don't consider these small and micro enterprises to provide financial support is that these enterprises are not incorporated and have no credit record or meaningful assets. As a consequence, these enterprises are unable to access credit through conventional banking channels as these channels need financial history, accurate personal data and a credit history of a borrower, enabling assessment of the credit risk. The entrepreneurs running such enterprises end up accessing credit through alternative channels and/or illegal syndicates which provide financial support at exorbitant rate of interest.

Further, Lenders (Individual and Institutional) are looking for investment opportunities to generate a reasonable return on their capital, but are unable to develop trust for lending financial support to an unknown borrower.

Some of the financial platforms do tailor connecting lenders with borrowers, however, such platforms suffer from the follows deficiencies:
Most of these platforms deploy loans in advanced economies only and primarily in the area of consumer credit.
They are based on “crowdfunding” models, where N users contribute to finance 1 loan.
Lender and borrower are not directly connected as intermediaries at various critical steps of the lending process are deployed for credit risk assessment, deployment and repayment of the loan etc.
These platforms typically require the use of a desktop computer by the borrower to sign up to connect to the platforms.
These platforms deploy either traditional banking systems or rely on third parties, typically community-based non-governmental organizations (NGOs), in order to determine credit risk.
Some of these platforms rely on traditional payments infrastructure to manage payments both ways. Traditional payment infrastructure typically deploys banking-based solutions like mainstream banking technologies, traditional bank transfer, or PayPal®.

### SUMMARY

This summary is provided to introduce aspects related to systems and methods for enabling financial transaction between a lender and a borrower and the aspects are further described below in the detailed description. This summary is not intended to identify essential features of the claimed subject matter nor is it intended for use in determining or limiting the scope of the claimed subject matter.

In one aspect, a system and method for connecting entrepreneurs/borrowers with one or more person interested in lending money, hereinafter referred as lender (whether natural or juristic person) located anywhere in the world, for provisioning and managing business loans is proposed. Further, the system also maintains a borrower mobile application to enable the borrowers to generate a borrower profile by providing critical information associated with themselves and/or their enterprise. Further, the web based application may be used by the lenders to browse through different borrower profiles created by entrepreneurs and select a profile to prospect lending opportunities suitable to their needs. Further, the system also provides the lenders with analysis tools to assess and manage the credit risk, sign online loan contracts, and monitor the loan performance. Once a loan has been agreed, the system provides with the means for the lenders to disburse and borrower with multiple options to receive and repay money respectively.

In one embodiment a method for enabling a financial transaction between a borrower and lender for provisioning and managing business loans is provided. The method may comprise processor implemented steps of: capturing borrower data corresponding to a selected borrower; analyzing the borrower data and obtaining a creditworthiness score corresponding to the selected borrower in a database; allowing access to the creditworthiness score and the borrower data to a lender using a web-based application; enabling a direct communication and exchange of legal documentation between the selected borrower and a lender using a messaging platform; and enabling a transfer of funds from the lender to the selected borrower and scheduling repayment intervals of a loan and maintaining electronic records therefor.

In one embodiment a system for enabling a financial transaction between a borrower and lender for provisioning and managing a business loan is provided. The system comprises at least one processor, an input/output (I/O) interface, and a memory with stored modules including: a borrower mobile interface module to receive borrower data; a lender web interface module to provide a lender a capability to connect to the stored modules of the system; a data analysis module to analyze the borrower data and display a matching profile as per the lenders inputs; and a financial transaction module to enable a funds transfer.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for provisioning financial transactions between a borrower and a lender, in accordance with an embodiment of the present subject matter.

FIG. 2 illustrates the system for provisioning financial transactions between a borrower and a lender, in accordance with an embodiment of the present subject matter.

FIG. 3 illustrated the flow of funds from a lender to a borrower according to one exemplary embodiment of the invention.

### DETAILED DESCRIPTION

The present subject matter relates to a system for enabling financial transactions between a borrower and a lender. The system is configured to enable a borrower mobile application designed for the borrowers to access the system and provide personal and financial details (borrower data) of their enterprise. The system also enables a web-based application or a lender mobile application for the lenders to access the system and identify a potential borrower matching their specification in order to lend money.

In one embodiment of the Invention the ‘borrower data’ includes data automatically captured and analyzed by the system from one or more online social media platform feeds, data extracted from other sources including the mobile application installed on the user/borrower mobile phone, data collected from open data sources and economic or geographic data sources in context of the user.

The system also enables an analysis tool that may be integrated to web-based application in order to assist the lender in identifying a potential borrower. The analysis tool may be configured to run background operations like analytics operations for determining the borrower's creditworthiness by processing the borrower data, monitoring the loan performance and the like. The analysis tool may also perform financial operations like loan disbursements or repayments and generate notifications in the form of push notifications, emails, and SMS for the lenders and the borrowers.

In one embodiment, the system may also enable a cryptocurrency (e.g. bitcoin or etherium etc.) based financial transaction for allowing the transfer of money, conversion of loans, and repayments between different currencies at a very low cost without involving any intermediary and/or merchant fees. The financial transaction platform may also allow users to receive and make payments either by traditional banking infrastructure or using alternative solutions for the unbanked entities which operate without any bank account.

In one embodiment the web-based application of the system as defined in the current invention acts as a marketplace wherein lenders register and view the various borrower loan requirements and are enabled to browse, selected and analyse the borrowers they would like to support.

While aspects of described system and method for enabling financial transaction between the borrower and the lender may be implemented in any number of different computing systems, environments, and/or configurations, the embodiments are described in the context of the following exemplary system.

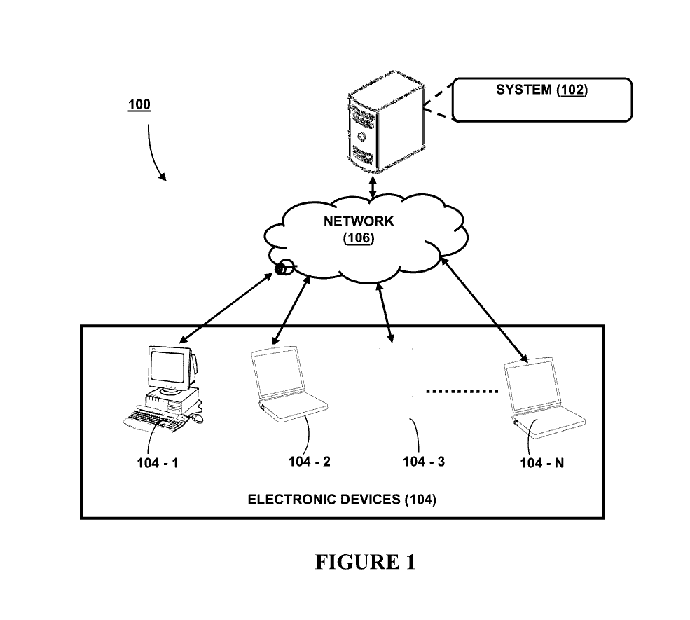

Referring now to FIG. 1, a network implementation 100 of a system 102 for enabling financial transaction between the borrower and the lender is disclosed in accordance with an embodiment of the present invention. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In one embodiment, the system 102 is configured to provide and validate personal and financial information associated with a set of borrower and classify the borrowers on a number of criteria such as country, sector, specific location, amount, credit risk, and the like. The system 102 also enables direct communication between lender and borrower through a dedicated messaging platform. Further, the system 102 provisions send and receive money in a secured and integrated manner by making use of virtual or cryptocurrency. The system 102 is further configured to schedule alarms to receive optimised automatic notifications for help the lender and borrower remembering their commitments and increase the repayment success rate. Further, the system 102 provides both lenders and borrowers with the legal documentation necessary to formalize the loan and relative terms.

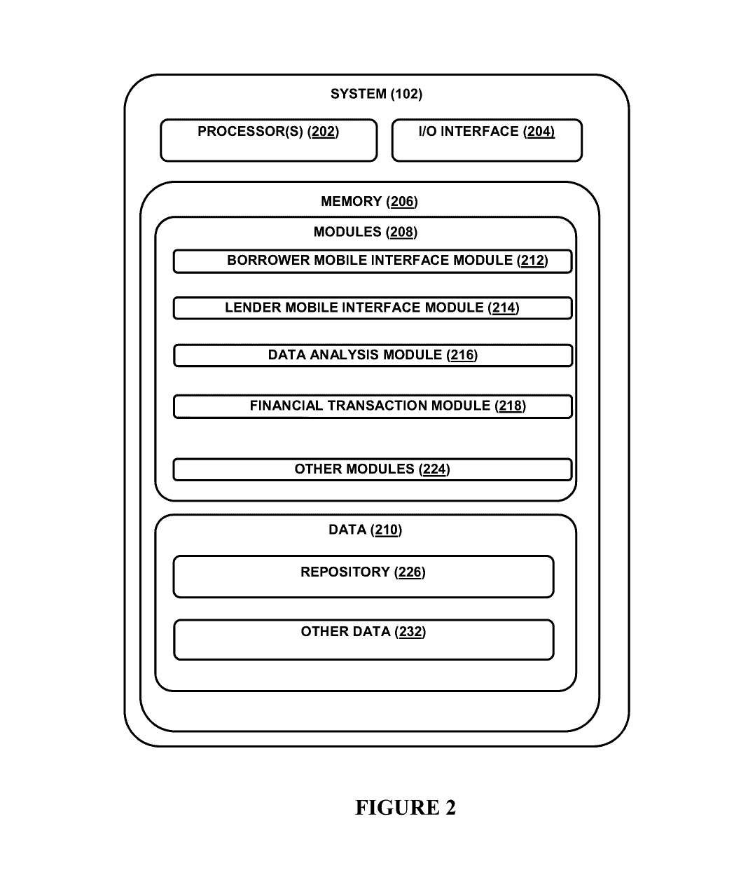

Referring now to FIG. 2, the system 102 for enabling financial transaction between the borrower and the lender is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks, functions or implement particular abstract data types. In one implementation, the modules 208 may include a borrower mobile application interface module 212, a lender web application interface module 214, a data analysis module 216, a financial transaction module 218, and other modules 224. The other modules 224 may include programs or coded instructions that supplement applications and functions of the system 102.

The data 210, amongst other things, serves as a repository for storing data processed, received, and generated by one or more of the modules 208. The data 210 may also include a repository 226, and other data 232. In one embodiment, the repository 226 may be configured to store information captured from the borrowers. Further, the other data 232 may include data generated as a result of the execution of one or more modules in the other module 224.

In one implementation, at first, a borrower may use a borrower mobile application over the user device 104 in order to access financial services for their small and micro enterprises. The borrower mobile application is configured to capture the borrowers' personal as well as professional information and transmit this information to the borrower mobile application interface module 212. The borrower mobile application interface module 212 is configured to generate a borrower profile based on this information captured. In a similar manner, information from all the borrowers is captured and borrower profiles are generated and stored in the repository 226.

In one embodiment, the system 102 enables the lender to communicate with the system/borrower using the lender web application. The lenders may browse through different borrower profiles stored in the repository 226 and select the best suitable profile in which he may want to invest. The system 102 enables the lender web application to communicate with the lender web interface module 214 and provide lenders with convenient access to a new type of investment in the form of small and micro enterprises that is currently not otherwise available, especially for individual investors. Further, the system 102 enables the lender to provide a new source of return of capital as well as an opportunity to diversify their current lending portfolio and better manage their risks by selecting borrower profile across different economic sectors, countries, and currencies.

In order to support the lender in decision making of lending money to a particular borrower, the system 102 provides a suite of tools enabled by the data analysis module 216 to analyse the different borrower profiles and decide the best profile as per the lenders requirements. The data analysis module 216 may also be configured to access the borrower's social media data, open data, geographic data and borrower mobile metadata in order to cross verify information provided by the borrowers. Once the lender selects a particular borrower profile, the system 102 enables end to end process for loan from disbursement to collection, by using the financial transaction module 218. The financial transaction module 218 is configured to enable a payment infrastructure designed to minimize transaction costs and reach borrowers even if they are located in remote areas and with no/limited access to traditional banking/encashment facilities. Further, the financial transaction module 218 enables a fast and secure way to transferring money between different currencies including virtual currencies. The system 102 provides the borrower and lender with the following advantages:
Direct communication between borrower and lender: the system 102 acts as an intermediary body at various critical steps of the money lending process such as credit risk assessment, deployment and repayment of the loan etc. The system 102 enables direct communication between the lender and the borrower using the mobile applications.
End-to-End and fully automated solution: the system 102 enables complete automation, management and monitoring of the entire lending process which involves agreements generation, loan disbursement, loan repayments, alarms, and recovery in case of default.
Direct lending options: unlike existing technologies which deploy crowdfunding models, where N users contribute to finance a single loan, the system 102 enables access to credit on a one to one approach.
Credit risk management: existing technologies deploy either traditional banking systems or rely on third parties and typical community-based NGOs, in order to determine credit risk. However, the system 102 uses a variety of data including open data and data based on social media usage to determine the credit risk of a small or medium enterprise. The system 102 analyses and cross reference data and information obtained from social media with open data and the data and information obtained from the entrepreneur associated with the small and macro enterprise.
Payments Infrastructure: The system 102 deploys a number of processes including virtual or cryptocurrency related infrastructure to transfer payments from lender to borrower and vice versa. Such processes are not only substantially less costly than existing technologies but also much faster.
Virtual or cryptocurrency related infrastructure: The system 102 enables virtual or cryptocurrency based infrastructure which allows transfer of money between different currencies in a secured way in only few minutes as compared to the traditional banking system where it usually takes days for the money transfer. The system also removes the need to integrate a third party (bank related technology) within the borrowing chain, reducing substantially the transaction costs by erasing any sort of merchant fees or other hidden costs and facilitating the administration of the full loan process within the infrastructure.
The alternative last mile solution: the system 102 enables integration of alternative ways to cover the last mile process (i.e., the payments and repayments—inside the platform allow a user to send and receive money out of the traditional banking system using eWallet, or cashpoints).

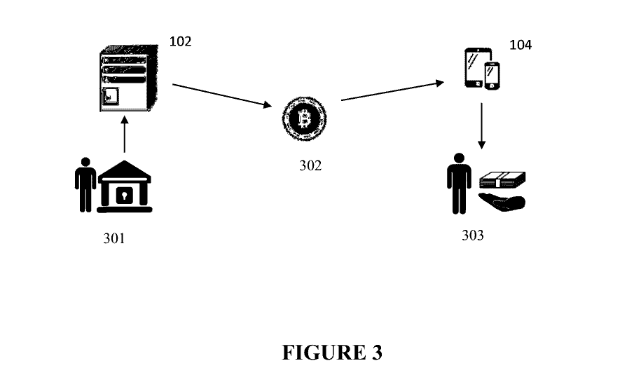

FIG. 3 describes an exemplary mode of carrying out the Invention. In one particular implementation the lender 301 provides instructions to the server 102 to transfer money from through his bank to the borrower 303. The server 102 is configured to convert the money in to a virtual or cryptocurrency, by known methods that bundle amongst other information including the address of the recipient user and the cryptographic signature of the sending user in an electronic message. The benefit of the money being transferred in the form of a cryptocurrency or virtual currency like bitcoin is that it reaches the borrower mobile device 104 in real-time and it can be further encashed in to currency notes and coins 303 at borrower's location. Thus the method is swift and safe.

Although implementations for methods and systems for enabling financial transaction between the borrower and the lender, it is to be understood that the appended claims are not necessarily limited to the specific features or methods described. Rather, the specific features and methods are disclosed as examples of implementations for enabling financial transaction between the borrower and the lender.

1. A method for enabling a financial transaction between a borrower and lender for provisioning and managing business loans, the method comprising processor implemented steps of:
capturing borrower data corresponding to a selected borrower;
analyzing the borrower data and obtaining a creditworthiness score corresponding to the selected borrower in a database;
allowing access to the creditworthiness score and the borrower data to a lender using a web-based application;
enabling a direct communication and exchange of legal documentation between the selected borrower and a lender using a messaging platform; and
enabling a transfer of funds from the lender to the selected borrower and scheduling repayment intervals of a loan and maintaining electronic records therefor.

2. The method as claimed in claim 1, wherein the borrower data comprises data from at least one of: online social media platform feeds, a mobile application installed on a mobile phone of the selected borrower, and open data sources including economic and geographic data sources.

3. The method as claimed in claim 1, wherein the funds are transferred in a form of at least one of: virtual funds and cryptocurrency.

4. The method as claimed in claim 3, wherein the at least one virtual funds and cryptocurrency is bitcoin.

5. The method as claimed in claim 2, wherein the borrower data is analyzed using an analytics engine.

6. The method as claimed in claim 1, wherein the creditworthiness score and the borrower data are stored in a database of a remote server.

7. The method as claimed in claim 1, wherein the selected borrower requires no bank account to receive the transferred funds.

8. A system for enabling a financial transaction between a borrower and lender for provisioning and managing business a loan, the system comprising:
at least one processor, an input/output (I/O) interface, and a memory with stored modules including:
a borrower mobile interface module to receive borrower data;
a lender web interface module to provide a lender a capability to connect to the stored modules of the system;
a data analysis module to analyze the borrower data and display a matching profile as per the lenders inputs; and
a financial transaction module to enable a funds transfer.

9. The system as claimed in claim 8, wherein the borrower data comprises data from at least one of: online social media platform feeds, a mobile application installed on a mobile phone of a borrower, and open data sources including economic and geographic data sources.

10. The system as claimed in claim 8, wherein the funds are transferred in a form of at least one of: virtual funds and cryptocurrency.

11. The system as claimed in claim 10, wherein the at least one virtual funds and cryptocurrency is bitcoin.

12. The system as claimed in claim 8, wherein the data analysis module is capable of collecting and analyzing the borrower data.

13. The system as claimed in claim 8, wherein the borrower requires no bank account to receive the transferred funds.

14. The system as claimed in claim 8, wherein the borrower data is stored in a database of a remote server.
